(19) United States
(12) Patent Application Publication
(10) Pub. No.: US 2025/0139187 A1
(43) Pub. Date: May 1, 2025

(54) AUTOMATICALLY GENERATING AND MODIFYING STYLE RULES

(71) Applicant: Capital One Services, LLC, McLean, VA (US)

(72) Inventors: Leeyat Bracha TESSLER, Arlington, VA (US); Claire M. ROWLETT, Washington, DC (US); Robert MAYS, Midlothian, VA (US); Daniel E. MILLER, Brooklyn, NY (US); Youbing YIN, Seattle, WA (US)

(21) Appl. No.: 18/496,393

(22) Filed: Oct. 27, 2023

(51) Int. Cl. G06F 16/957; G06F 40/143

(52) U.S. Cl. CPC G06F 16/9577; G06F 40/143

(57) ABSTRACT

In some implementations, a style system may receive, from a repository, a plurality of files associated with an entity. The style system may apply a machine learning model to the plurality of files to determine a set of rules associated with images or text included in the plurality of files. The style system may generate a document that indicates the set of rules and may output, to a user device, the document.

### BACKGROUND

Files associated with an entity (e.g., an organization, such as a corporation, or a group, such as an advocacy group) may represent media for digital distribution (e.g., email messages or webpages, among other examples) and/or media for physical distribution (e.g., mailers or posters, among other examples).

### SUMMARY

Some implementations described herein relate to a system for automatically generating and modifying style rules. The system may include one or more memories and one or more processors communicatively coupled to the one or more memories. The one or more processors may be configured to receive, at a first time, a plurality of files associated with an entity. The one or more processors may be configured to apply a machine learning model to the plurality of files to determine a set of rules associated with images or text included in the plurality of files. The one or more processors may be configured to generate a hypertext markup language (HTML) page that indicates the set of rules. The one or more processors may be configured to transmit the HTML page for display on an intranet associated with the entity. The one or more processors may be configured to receive, at a second time subsequent to the first time, a plurality of additional files associated with the entity. The one or more processors may be configured to apply the machine learning model to the plurality of additional files to determine at least one modification to the set of rules. The one or more processors may be configured to transmit an instruction to modify the HTML page to indicate the at least one modification to the set of rules.

Some implementations described herein relate to a method of automatically generating and publishing style rules. The method may include receiving, from a repository, a plurality of files associated with an entity. The method may include applying, by a style system, a machine learning model to the plurality of files to determine a set of rules associated with images or text included in the plurality of files. The method may include generating, by the style system, a document that indicates the set of rules. The method may include transmitting, to a user device, the document.

Some implementations described herein relate to a non-transitory computer-readable medium that stores a set of instructions for automatically modifying style rules. The set of instructions, when executed by one or more processors of a device, may cause the device to receive at least one document indicating a style guide associated with an entity. The set of instructions, when executed by one or more processors of the device, may cause the device to receive a plurality of files associated with the entity. The set of instructions, when executed by one or more processors of the device, may cause the device to apply a machine learning model to the at least one document and the plurality of files to determine at least one modification to the at least one document. The set of instructions, when executed by one or more processors of the device, may cause the device to transmit, to a user device, an indication of the at least one modification.

### BRIEF DESCRIPTION OF THE DRAWINGS

FIGS. 1A-1D are diagrams of an example implementation relating to automatically generating and modifying style rules, in accordance with some embodiments of the present disclosure.

FIGS. 2A-2B are diagrams illustrating an example of training and using a machine learning model, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to automatically generating and modifying style rules, in accordance with some embodiments of the present disclosure.

### DETAILED DESCRIPTION

The following detailed description of example implementations refers to the accompanying drawings. The same reference numbers in different drawings may identify the same or similar elements.

An entity (e.g., an organization, such as a corporation, or a group, such as an advocacy group) may produce files for distribution. For example, the files may represent media for digital distribution (e.g., email messages or webpages, among other examples) and/or media for physical distribution (e.g., mailers or posters, among other examples). Different users throughout the entity may contribute to the files.

Generally, the entity may establish rules (e.g., based on a style guide) that govern production of media. However, establishing the rules usually involves multiple communications between users in the entity. These communications consume power, processing resources, and network overhead. Additionally, user interactions that trigger publication of the rules consume additional power and processing resources.

Some implementations described herein enable automatically generating a set of rules for an entity. For example, a machine learning model may generate the set of rules based on a plurality of files associated with the entity. As a result, power, processing resources, and network overhead are conserved that would otherwise have been consumed in establishing the set of rules by using multiple communications between users. The machine learning model may also perform automatic updates to the set of rules, which further conserves power, processing resources, and network overhead that would otherwise have been consumed in updating the set of rules by using multiple communications between users. Additionally, the machine learning model may automatically output the set of rules as a document (e.g., a portable document format (PDF) document) and/or to an intranet associated with the entity. As a result, power and processing resources are conserved that would otherwise have been consumed in processing user interactions that trigger publication of the set of rules.

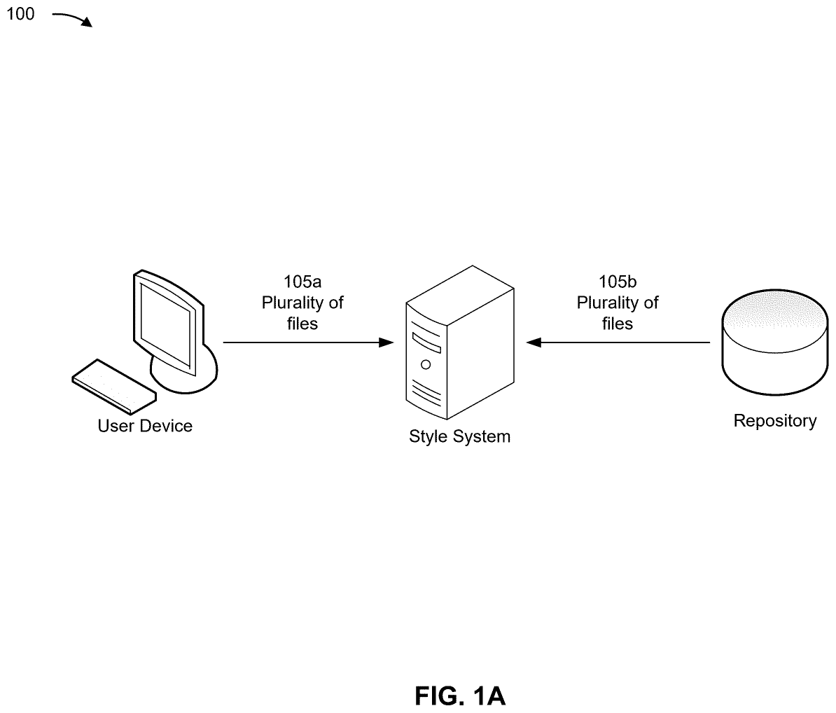

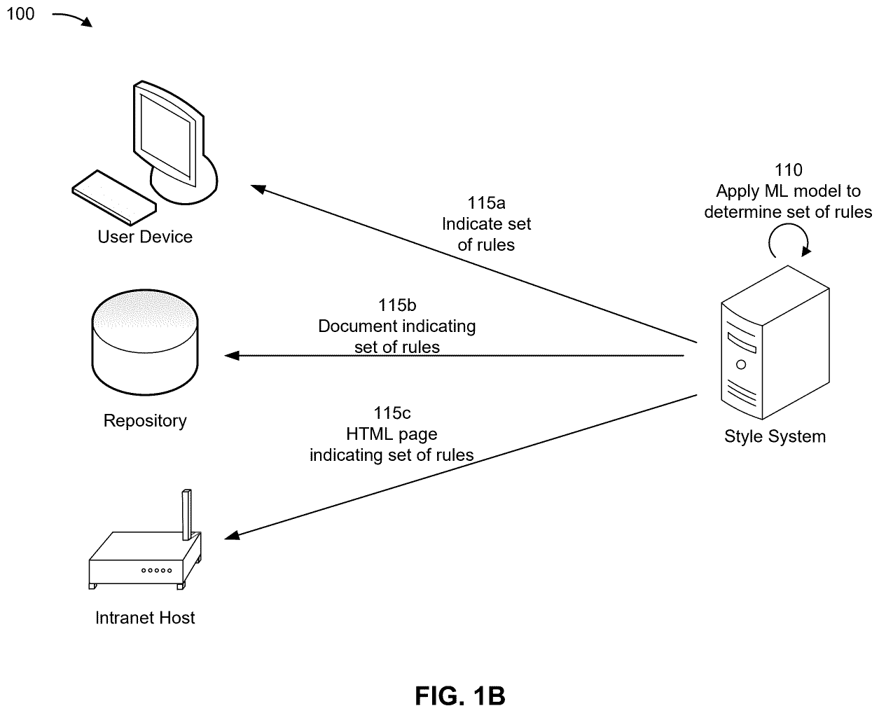

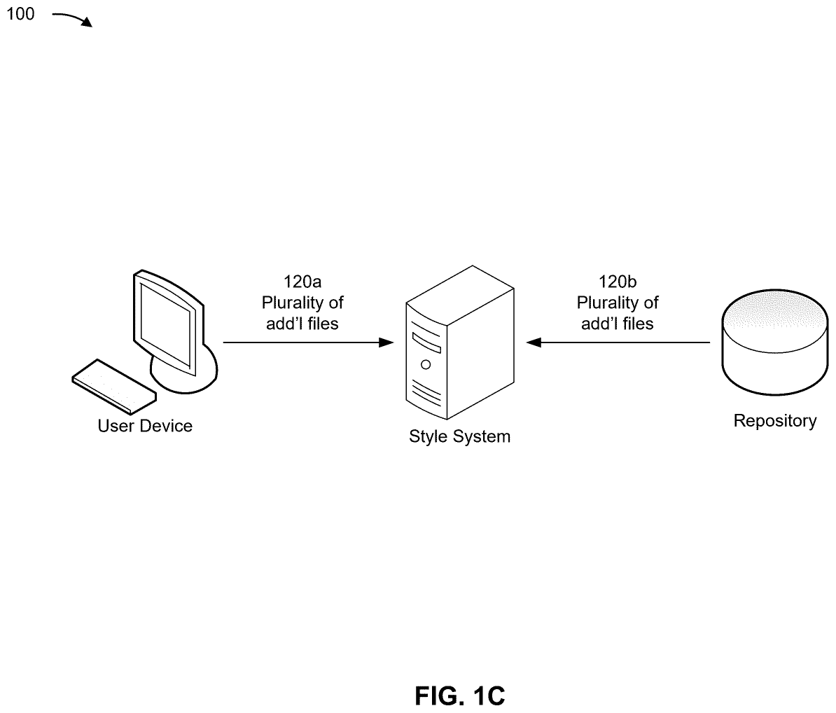

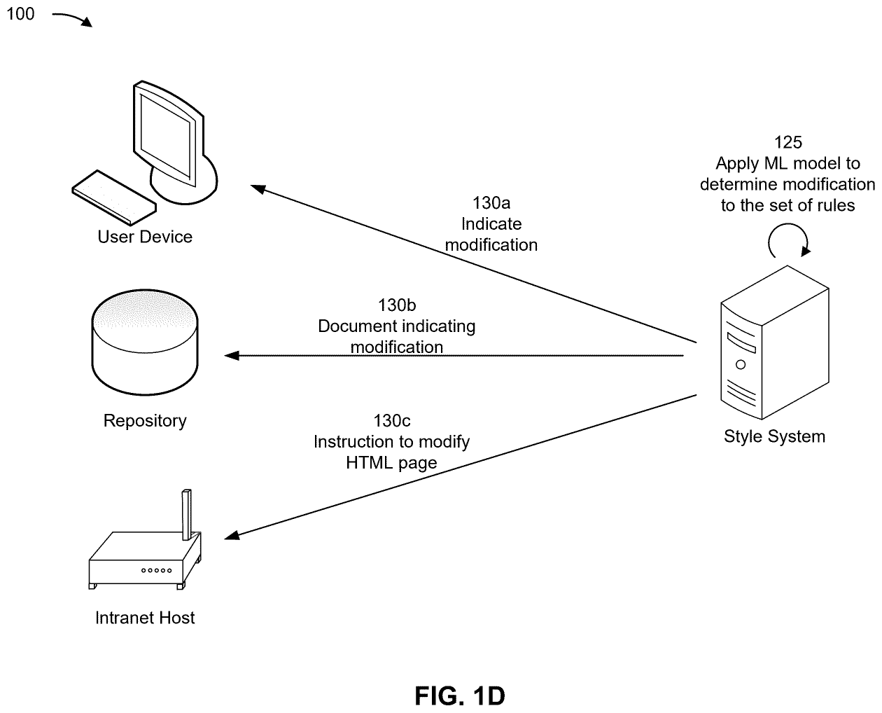

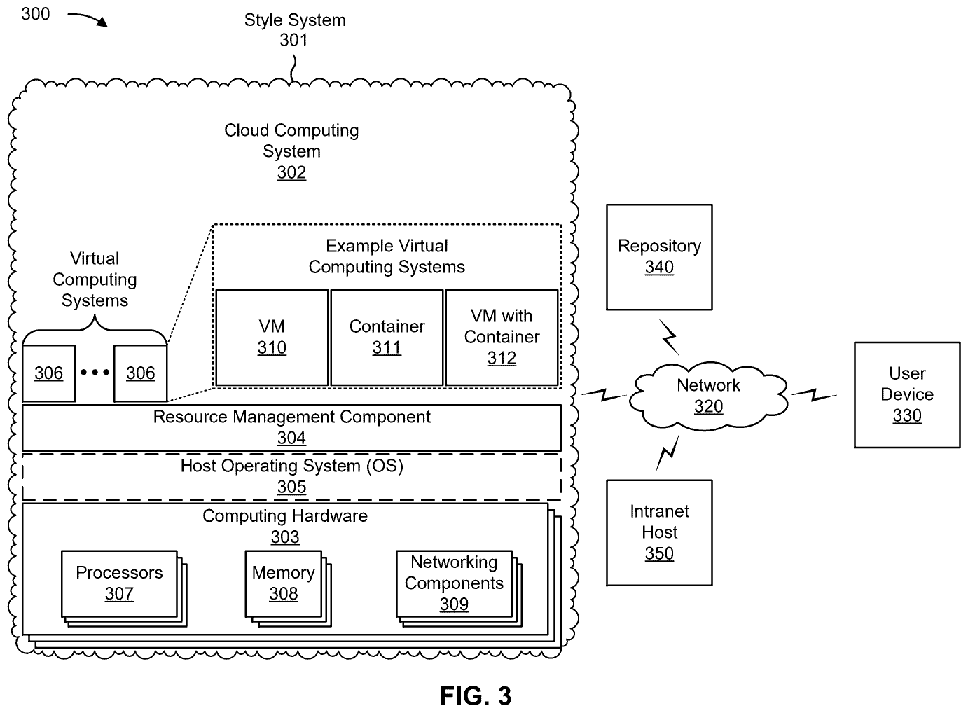

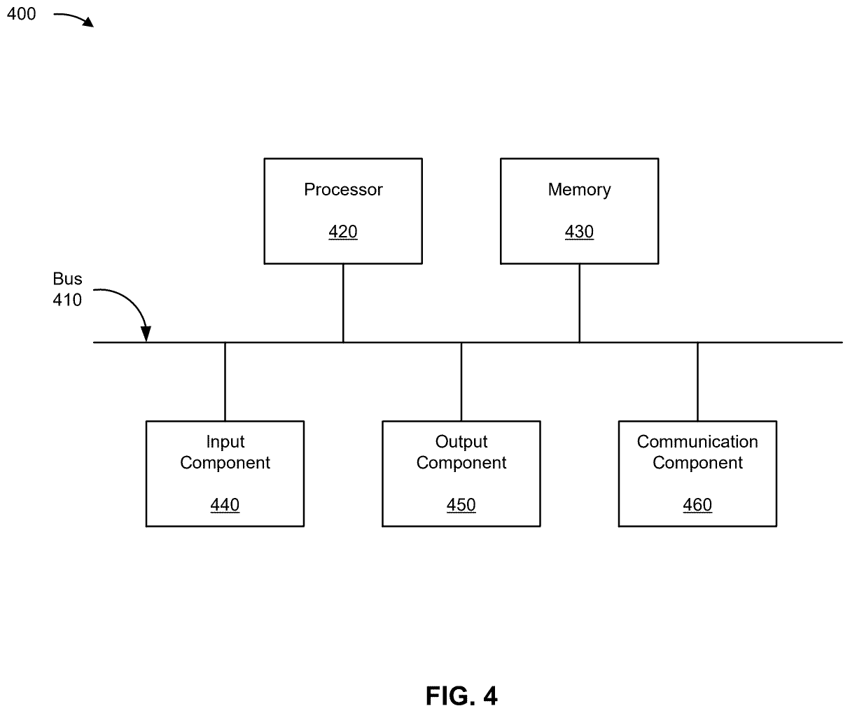

FIGS. 1A-1D are diagrams of an example 100 associated with automatically generating and modifying style rules. As shown in FIGS. 1A-1D, example 100 includes a user device, a repository, a style system, and an intranet host. These devices are described in more detail in connection with FIGS. 3 and 4.

As shown in FIG. 1A and by reference number 105a, the user device may transmit, and the style system may receive, a plurality of files associated with an entity. The plurality of files may represent media for digital distribution (e.g., email messages or webpages, among other examples) and/or media for physical distribution (e.g., mailers or posters, among other examples). For example, the plurality of files may include an image file, a video file, a hypertext markup language (HTML) file, and/or a PDF document, among other examples.

The user device may use a file transfer protocol (FTP) or another similar type of protocol to upload the plurality of files to the style system. In some implementations, a user of the user device may provide input (e.g., via an input component of the user device) that triggers the user device to transmit the plurality of files. The input may include interaction with a user interface (UI) (e.g., output via an output component of the user device) that triggers the user device to transmit the plurality of files. For example, the input may include interaction with an input element (e.g., a text box) to indicate a location (or locations) of the plurality of files (whether local to the user device or at least partially remote from the user device) and/or interaction with an action element (e.g., a button) to trigger the user device to upload the plurality of files.

In some implementations, the style system may authenticate the user device before accepting the plurality of files. For example, the user device may transmit, and the style system may receive, a set of credentials (e.g., a username and password, a passcode, a certificate, a private key, and/or an access token, among other examples). The style system may thus validate the set of credentials before receiving the plurality of files. In some implementations, a single sign on (SSO) service associated with the user device may perform the authentication. Accordingly, the SSO service may transmit, and the style system may receive, an authorization, and the style system may receive the plurality of files based on the authorization from the SSO service.

Additionally, or alternatively, as shown by reference number 105b, the repository may transmit, and the style system may receive, the plurality of files associated with the entity. The repository may store digital assets associated with the entity. In some implementations, the style system may transmit, and the repository may receive, a request for the plurality of files. Therefore, the repository may transmit, and the style system may receive, the plurality of files in response to the request. The repository may be local to the style system (e.g., a cache or another type of memory controlled by the style system), such that the request includes a memory read command. Alternatively, the repository may be at least partially separate (e.g., logically, virtually, and/or physically) from the style system, such that the request includes a hypertext transfer protocol (HTTP) request, an FTP request, and/or an application programming interface (API) call, among other examples.

In a combinatory example, the user device may transmit, and the style system may receive, an indication of a location (or locations) associated with the plurality of files. The location may include a folder name, a file path, an alphanumeric identifier associated with the plurality of files, and/or another type of identifier that indicates where the plurality of files are stored. Accordingly, the style system may transmit, and the repository may receive, a request for the digital file based on the location(s) (which indicates that the plurality of files are stored in the repository). Therefore, the repository may transmit, and the style system may receive, the plurality of files in response to the request.

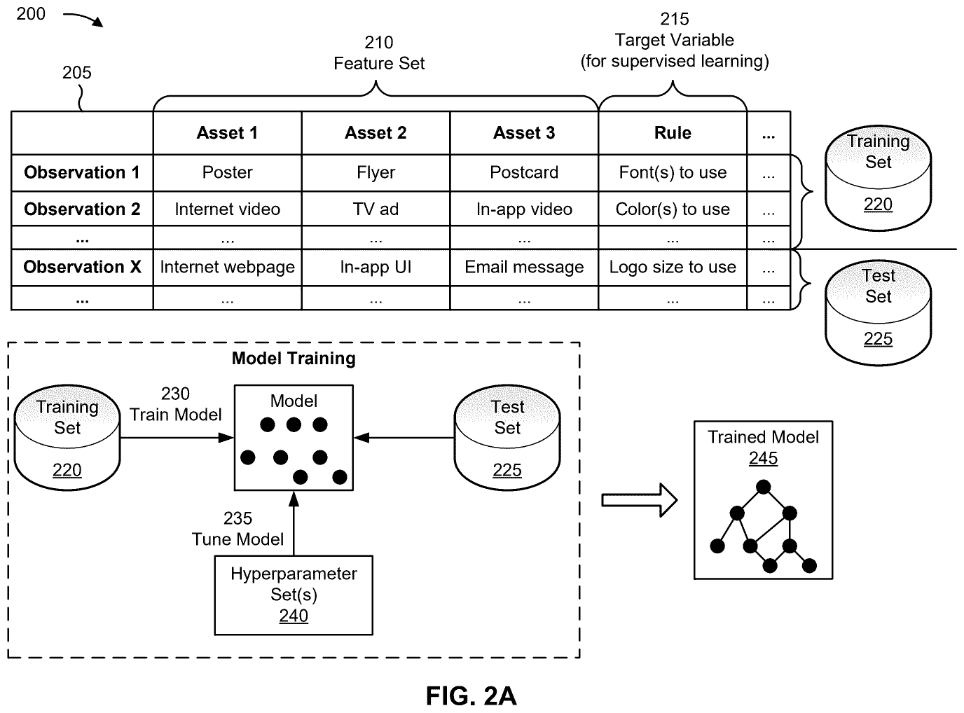

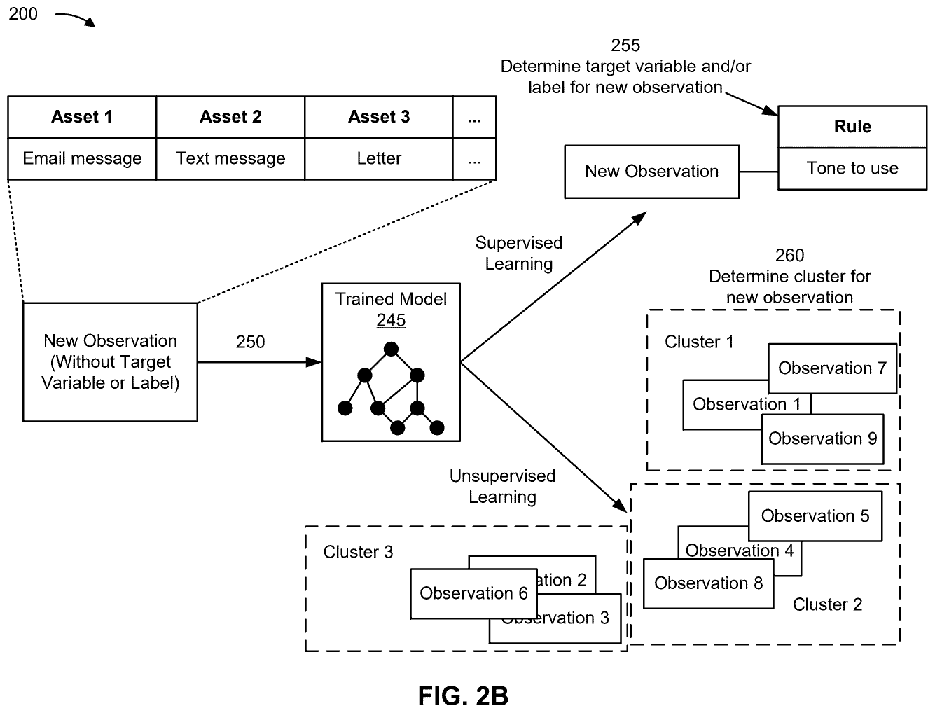

As shown in FIG. 1B and by reference number 110, the style system may apply a machine learning model to the plurality of files to determine a set of rules. The set of rules may be associated with images or text included in the plurality of files. For example, the set of rules may include an illustration style rule (e.g., a range of line thicknesses to use and/or a color palette to use), a color rule (e.g., a set of colors to use and/or a proportion of colors to use), an image size rule (e.g., an aspect ratio to use and/or sizes to use in pixels), a tone rule (e.g., a tone, as determined by a tone analysis model, to use), a grammar rule (e.g., whether to use Oxford commas and/or whether to use US or UK spelling), and/or a font rule (e.g., a font to use and/or a font size to use), among other examples. The machine learning model may be trained and used as described in connection with FIGS. 2A-2B.

In some implementations, the style system may train the machine learning model using the plurality of files such that the machine learning model outputs the set of rules once trained. Additionally, or alternatively, the style system may input the plurality of files to the machine learning model (after training) such that the machine learning model outputs the set of rules.

In some implementations, the user device may transmit, and the style system may receive, an indication of features (e.g., one or more features) to use in the machine learning model. For example, a user of the user device may provide input (e.g., via an input component of the user device) that triggers the user device to transmit the indication. The input may include interaction with a UI (e.g., output via an output component of the user device) that triggers the user device to transmit the indication. The input may include interaction with input elements (e.g., checkboxes and/or radio buttons) to indicate the features. Accordingly, the machine learning model may be customized to identify particular rules and/or to assess particular portions of the plurality of files (e.g., images, tone, font, and so on). Additionally, or alternatively, the machine learning model may use deep learning. Accordingly, the machine learning model may, without constraint, identify rules and/or assess particular portions of the plurality of files.

In some implementations, the machine learning model may include a single model. Alternatively, the machine learning model may include a suite of models. For example, the style system may apply a first machine learning model to determine a first portion of the set of rules associated with a first style category (e.g., fonts) and may apply a second machine learning model to determine a second portion of the set of rules associated with a second style category (e.g., images). Other examples may include additional models within the suite.

By using the machine learning model, the style system conserves power, processing resources, and network overhead that would otherwise have been consumed in establishing the set of rules by using multiple communications between users.

In some implementations, as shown by reference number 115a, the style system may transmit, and the user device may receive, an indication of the set of rules. The indication may include a document (e.g., an HTML page and/or a PDF document, among other examples) that indicates the set of rules. In some implementations, the style system may generate and output the document in response to a confirmation from the user device. For example, a user of the user device may provide input (e.g., via an input component of the user device) that triggers the user device to transmit the confirmation. The input may include interaction with a UI (e.g., output via an output component of the user device) that triggers the user device to transmit the confirmation. For example, the input may include interaction with an action element (e.g., a button) to trigger the user device to transmit the confirmation.

Additionally, or alternatively, as shown by reference number 115b, the style system may transmit, and the repository may receive, a document indicating the set of rules. In some implementations, the style system may transmit the document for storage in response to a confirmation from the user device. For example, a user of the user device may provide input (e.g., via an input component of the user device) that triggers the user device to transmit the confirmation to the style system. The input may include interaction with a UI (e.g., output via an output component of the user device) that triggers the user device to transmit the confirmation. For example, the input may include interaction with an action element (e.g., a button) to trigger the user device to transmit the confirmation.

Additionally, or alternatively, as shown by reference number 115c, the style system may transmit, and the intranet host may receive, an HTML page that indicates the set of rules. Accordingly, the HTML page may be for display on an intranet associated with the entity. In some implementations, the style system may transmit the HTML page for display in response to a confirmation from the user device. For example, a user of the user device may provide input (e.g., via an input component of the user device) that triggers the user device to transmit the confirmation to the style system. The input may include interaction with a UI (e.g., output via an output component of the user device) that triggers the user device to transmit the confirmation. For example, the input may include interaction with an action element (e.g., a button) to trigger the user device to transmit the confirmation.

By integrating with the intranet host, the style system conserves power and processing resources that would otherwise have been consumed in processing user interactions that trigger publication of the set of rules.

At a later time (e.g., a second time subsequent to a first time when the plurality of files were received), the style system may update the machine learning model. As shown in FIG. 1C and by reference number 120a, the user device may transmit, and the style system may receive, a plurality of additional files associated with the entity (e.g., similarly as is described in connection with reference number 105a). Additionally, or alternatively, as shown by reference number 120b, the repository may transmit, and the style system may receive, the plurality of additional files associated with the entity (e.g., similarly as is described in connection with reference number 105b).

As shown in FIG. 1D and by reference number 125, the style system may apply the machine learning model to the plurality of additional files to determine a modification (e.g., at least one modification) to the set of rules. The machine learning model may be as described in connection with FIGS. 2A-2B.

In some implementations, the style system may re-train the machine learning model using the plurality of additional files. Therefore, the style system may compare output from the trained machine learning model with output from the re-trained machine learning model to determine the modification. Additionally, or alternatively, the style system may input the plurality of additional files to the machine learning model (after re-training) such that the machine learning model outputs an updated set of rules, and the style system may compare the updated set of rules to the original set of rules to determine the modification.

In some implementations, the style system may receive (e.g., from the user device, the repository, and/or the intranet host), a document (e.g., at least one document) indicating a style guide associated with the entity. The document may include an HTML page or another type of document. Accordingly, the style system may train the machine learning model using the document. Therefore, the style system may input the plurality of additional files to the machine learning model (after training) such that the machine learning model outputs an indication of the modification. Alternatively, the machine learning model may output an updated set of rules, and the style system may compare the updated set of rules to the original set of rules to determine the modification.

Using the machine learning model to automatically update the set of rules further conserves power, processing resources, and network overhead that would otherwise have been consumed in updating the set of rules by using multiple communications between users.

In some implementations, as shown by reference number 130a, the style system may transmit, and the user device may receive, an indication of the modification. The indication may include a document that indicates the modification (e.g., a document with tracked changes, among other examples). In some implementations, the style system may generate and output the document in response to a confirmation from the user device, as described in connection with reference number 115a.

Additionally, or alternatively, as shown by reference number 130b, the style system may transmit, and the repository may receive, a document indicating the modification. In some implementations, the style system may transmit the document for storage in response to a confirmation from the user device, as described in connection with reference number 115b. Additionally, or alternatively, the style system may transmit an instruction to update the document previously stored in the repository in order to reflect the modification.

Additionally, or alternatively, as shown by reference number 130c, the style system may transmit, and the intranet host may receive, an instruction to modify the HTML page to indicate the modification. In some implementations, the style system may transmit the instructions in response to a confirmation from the user device, similarly as is described in connection with reference number 115b.

By integrating with the intranet host, the style system conserves power and processing resources that would otherwise have been consumed in processing user interactions that trigger publication of the modification.

By using techniques as described in connection with FIGS. 1A-1D, the machine learning model generates the set of rules based on the plurality of files associated with the entity. As a result, power, processing resources, and network overhead are conserved that would otherwise have been consumed in establishing the set of rules by using multiple communications between users. The machine learning model also performs automatic updates to the set of rules, which further conserves power, processing resources, and network overhead that would otherwise have been consumed in updating the set of rules by using multiple communications between users.

As indicated above, FIGS. 1A-1D are provided as an example. Other examples may differ from what is described with regard to FIGS. 1A-1D.

FIGS. 2A-2B are diagrams illustrating an example 200 of training and using a machine learning model in connection with automatically generating and modifying style rules. The machine learning model training described herein may be performed using a machine learning system. The machine learning system may include or may be included in a computing device, a server, a cloud computing environment, or the like, such as the style system described herein.

As shown in FIG. 2A and by reference number 205, a machine learning model may be trained using a set of observations. The set of observations may be obtained and/or input from training data (e.g., historical data), such as data gathered during one or more processes described herein. For example, the set of observations may include data gathered from the repository, as described elsewhere herein. In some implementations, the machine learning system may receive the set of observations (e.g., as input) from the style system.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the style system. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a first digital asset, a second feature of a second digital asset, a third feature of a third digital asset, and so on. As shown, for a first observation, the first feature may represent a post, the second feature may represent a flyer, the third feature may represent a postcard, and so on. These features and feature values are provided as examples, and may differ in other examples. For example, the feature set may include additional or alternative digital assets. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a rule, which is a font rule for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that may include a first subset of observations, of the set of observations, and a test set 225 that may include a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 2B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

FIG. 2B illustrates applying the trained machine learning model 245 to a new observation. As shown by reference number 250, the machine learning system may receive a new observation (or a set of new observations), and may input the new observation to the machine learning model 245. As shown, the new observation may include a first feature of a first digital asset, a second feature of a second digital asset, a third feature of a third digital asset, and so on, as an example. The machine learning system may apply the trained machine learning model 245 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 245 may predict a tone rule for the target variable for the new observation, as shown by reference number 255. Based on this prediction (e.g., based on the value having a particular label or classification or based on the value satisfying or failing to satisfy a threshold), the machine learning system may provide a recommendation and/or output for determination of a recommendation, such as a modification to an existing tone rule. Additionally, or alternatively, the machine learning system may perform an automated action and/or may cause an automated action to be performed (e.g., by instructing another device to perform the automated action), such as generating an update to a document to reflect the tone rule. As another example, if the machine learning system were to predict a font rule for the target variable, then the machine learning system may provide a different recommendation (e.g., a modification to an existing font rule) and/or may perform or cause performance of a different automated action (e.g., generating an update to a document to reflect the font rule). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 245 may classify (e.g., cluster) the new observation in a cluster, as shown by reference number 260. The observations within a cluster may have a threshold degree of similarity. As an example, if the machine learning system classifies the new observation in a first cluster (e.g., compliant with an existing style guide), then the machine learning system may provide a first recommendation, such as preserving the existing style guide. Additionally, or alternatively, the machine learning system may perform a first automated action and/or may cause a first automated action to be performed (e.g., by instructing another device to perform the automated action) based on classifying the new observation in the first cluster, such as refraining from modifying the existing style guide. As another example, if the machine learning system were to classify the new observation in a second cluster (e.g., non-compliant with an existing style guide), then the machine learning system may provide a second (e.g., different) recommendation (e.g., modifying the existing style guide) and/or may perform or cause performance of a second (e.g., different) automated action, such as generating a modification to the existing style guide.

In this way, the machine learning system may apply a rigorous and automated process to generating and updating a style guide. The machine learning system may enable recognition and/or identification of tens, hundreds, thousands, or millions of features and/or feature values for tens, hundreds, thousands, or millions of observations, thereby increasing accuracy and consistency and reducing delay associated with generating and updating a style guide relative to requiring computing resources to be allocated for tens, hundreds, or thousands of operators to communicate and determine the style guide and updates to the style guide using the features or feature values.

As indicated above, FIGS. 2A-2B are provided as an example. Other examples may differ from what is described in connection with FIGS. 2A-2B. For example, the machine learning model may be trained using a different process than what is described in connection with FIG. 2A. Additionally, or alternatively, the machine learning model may employ a different machine learning algorithm than what is described in connection with FIGS. 2A-2B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram of an example environment 300 in which systems and/or methods described herein may be implemented. As shown in FIG. 3, environment 300 may include a style system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, a repository 340, and/or an intranet host 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the style system 301 may include one or more elements 303-312 of the cloud computing system 302, may execute within the cloud computing system 302, and/or may be hosted within the cloud computing system 302, in some implementations, the style system 301 may not be cloud-based (e.g., may be implemented outside of a cloud computing system) or may be partially cloud-based. For example, the style system 301 may include one or more devices that are not part of the cloud computing system 302, such as device 400 of FIG. 4, which may include a standalone server or another type of computing device. The style system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with digital assets, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The repository 340 may include one or more devices capable of receiving, generating, storing, processing, and/or providing information associated with digital assets, as described elsewhere herein. The repository 340 may include a communication device and/or a computing device. For example, the repository 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The repository 340 may communicate with one or more other devices of environment 300, as described elsewhere herein.

The intranet host 350 may include one or more devices capable of receiving, generating, storing, processing, providing, and/or routing information associated with HTML pages, as described elsewhere herein. The intranet host 350 may include a communication device and/or a computing device. For example, the intranet host 350 may include a server, such as an application server, a client server, a web server, a database server, a host server, a proxy server, a virtual server (e.g., executing on computing hardware), or a server in a cloud computing system. In some implementations, the intranet host 350 may include computing hardware used in a cloud computing environment. The intranet host 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with automatically generating and modifying style rules. The device 400 may correspond to a user device 330, a repository 340, and/or an intranet host 350. In some implementations, a user device 330, a repository 340, and/or an intranet host 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

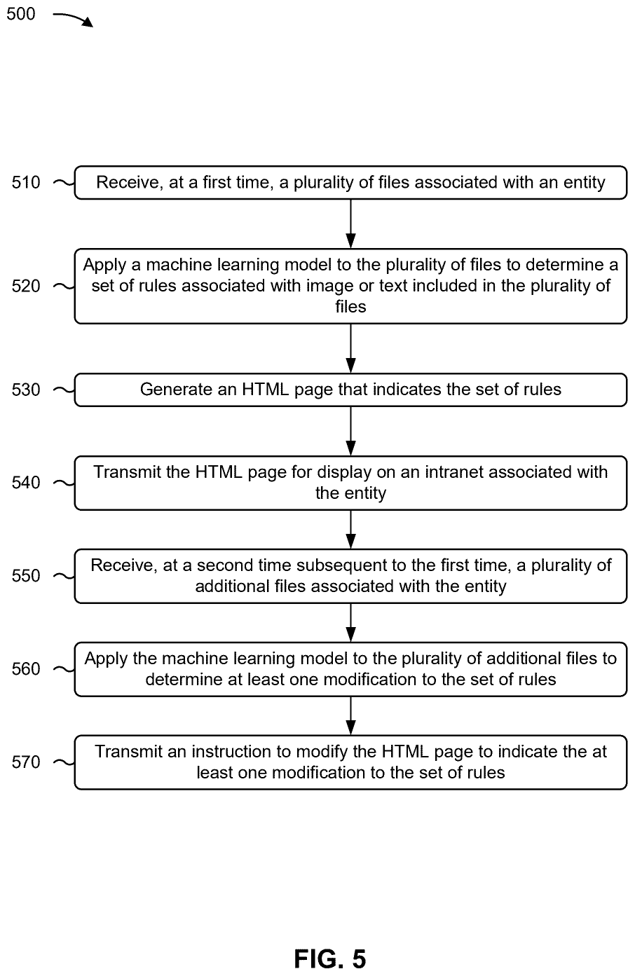

FIG. 5 is a flowchart of an example process 500 associated with automatically generating and modifying style rules. In some implementations, one or more process blocks of FIG. 5 may be performed by a style system 301. In some implementations, one or more process blocks of FIG. 5 may be performed by another device or a group of devices separate from or including the style system 301, such as a user device 330, a repository 340, and/or an intranet host 350. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, at a first time, a plurality of files associated with an entity (block 510). For example, the style system 301 (e.g., using processor 420, memory 430, input component 440, and/or communication component 460) may receive, at a first time, a plurality of files associated with an entity, as described above in connection with reference number 105a and/or reference number 105b of FIG. 1A. As an example, the style system 301 may receive the plurality of files from a user device. Additionally, or alternatively, the style system 301 may receive the plurality of files from a repository.

As further shown in FIG. 5, process 500 may include applying a machine learning model to the plurality of files to determine a set of rules associated with images or text included in the plurality of files (block 520). For example, the style system 301 (e.g., using processor 420 and/or memory 430) may apply a machine learning model to the plurality of files to determine a set of rules associated with images or text included in the plurality of files, as described above in connection with reference number 110 of FIG. 1B. As an example, the style system 301 may train the machine learning model using the plurality of files such that the machine learning model outputs the set of rules once trained. Additionally, or alternatively, the style system 301 may input the plurality of files to the machine learning model (after training) such that the machine learning model outputs the set of rules.

As further shown in FIG. 5, process 500 may include generating an HTML page that indicates the set of rules (block 530). For example, the style system 301 (e.g., using processor 420 and/or memory 430) may generate an HTML page that indicates the set of rules, as described above in connection with FIG. 1B. As an example, the HTML page may list the set of rules.

As further shown in FIG. 5, process 500 may include transmitting the HTML page for display on an intranet associated with the entity (block 540). For example, the style system 301 (e.g., using processor 420, memory 430, and/or communication component 460) may transmit the HTML page for display on an intranet associated with the entity, as described above in connection with reference number 115c of FIG. 1B. As an example, the style system 301 may transmit the HTML page for display in response to a confirmation from a user device.

As further shown in FIG. 5, process 500 may include receiving, at a second time subsequent to the first time, a plurality of additional files associated with the entity (block 550). For example, the style system 301 (e.g., using processor 420, memory 430, input component 440, and/or communication component 460) may receive, at a second time subsequent to the first time, a plurality of additional files associated with the entity, as described above in connection with reference number 120a and/or reference number 120b of FIG. 1C. As an example, the style system 301 may receive the plurality of additional files from a user device. Additionally, or alternatively, the style system 301 may receive the plurality of additional files from a repository.

As further shown in FIG. 5, process 500 may include applying the machine learning model to the plurality of additional files to determine at least one modification to the set of rules (block 560). For example, the style system 301 (e.g., using processor 420 and/or memory 430) may apply the machine learning model to the plurality of additional files to determine at least one modification to the set of rules, as described above in connection with reference number 125 of FIG. 1D. As an example, the style system 301 may re-train the machine learning model using the plurality of additional files. Therefore, the style system 301 may compare output from the trained machine learning model with output from the re-trained machine learning model to determine the at least one modification. In another example, the style system 301 may train the machine learning model using at least one document indicating a style guide associated with the entity. Therefore, the style system 301 may input the plurality of additional files to the machine learning model (after training) such that the machine learning model outputs an indication of the at least one modification.

As further shown in FIG. 5, process 500 may include transmitting an instruction to modify the HTML page to indicate the at least one modification to the set of rules (block 570). For example, the style system 301 (e.g., using processor 420, memory 430, and/or communication component 460) may transmit an instruction to modify the HTML page to indicate the at least one modification to the set of rules, as described above in connection with reference number 130c of FIG. 1D. As an example, the style system 301 may transmit the instruction in response to a confirmation from a user device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automatically generating and modifying style rules, the system comprising:
one or more memories; and
one or more processors, communicatively coupled to the one or more memories, configured to:
receive, at a first time, a plurality of files associated with an entity;
apply a machine learning model to the plurality of files to determine a set of rules associated with images or text included in the plurality of files;
generate a hypertext markup language (HTML) page that indicates the set of rules;
transmit the HTML page for display on an intranet associated with the entity;
receive, at a second time subsequent to the first time, a plurality of additional files associated with the entity;
apply the machine learning model to the plurality of additional files to determine at least one modification to the set of rules; and
transmit an instruction to modify the HTML page to indicate the at least one modification to the set of rules.

2. The system of claim 1, wherein the one or more processors are configured to:
train the machine learning model using the plurality of files; and
re-train the machine learning model using the plurality of additional files,
wherein the at least one modification is determined based on comparing output from the trained machine learning model with output from the re-trained machine learning model.

3. The system of claim 1, wherein the one or more processors are configured to:
input the HTML page to the machine learning model,
wherein the at least one modification to the set of rules is determined based on the HTML page and the plurality of additional files.

4. The system of claim 1, wherein the one or more processors, to transmit the HTML page, are configured to:
transmit, to a user device, the HTML page;
receive, from the user device, a confirmation; and
transmit the HTML page for display on the intranet in response to the confirmation.

5. The system of claim 1, wherein the one or more processors, to receive the plurality of files, are configured to:
receive the plurality of files from a user device.

6. The system of claim 1, wherein the one or more processors, to receive the plurality of files, are configured to:
transmit, to a repository, a request for the plurality of files; and
receive, from the repository, the plurality of files in response to the request.

7. A method of automatically generating and publishing style rules, comprising:
receiving, from a repository, a plurality of files associated with an entity;
applying, by a style system, a machine learning model to the plurality of files to determine a set of rules associated with images or text included in the plurality of files;
generating, by the style system, a document that indicates the set of rules; and
transmitting, to a user device, the document.

8. The method of claim 7, wherein the set of rules includes one or more of:
an illustration style rule;
a color rule;
an image size rule;
a tone rule;
a grammar rule; or
a font rule.

9. The method of claim 7, further comprising:
receiving, from the user device, a confirmation; and
transmitting the document for display on an intranet, associated with the entity, in response to the confirmation.

10. The method of claim 7, further comprising:
receiving, from the user device, a confirmation; and
outputting the document in a portable document format.

11. The method of claim 7, further comprising:
receiving, from the user device, an indication of one or more features to use in the machine learning model.

12. The method of claim 7, wherein the machine learning model uses deep learning.

13. The method of claim 7, wherein applying the machine learning model comprises:
applying a first machine learning model to determine a first portion of the set of rules associated with a first style category; and
applying a second machine learning model to determine a second portion of the set of rules associated with a second style category.

14. A non-transitory computer-readable medium storing a set of instructions for automatically modifying style rules, the set of instructions comprising:
one or more instructions that, when executed by one or more processors of a device, cause the device to:
receive at least one document indicating a style guide associated with an entity;
receive a plurality of files associated with the entity;
apply a machine learning model to the at least one document and the plurality of files to determine at least one modification to the at least one document; and
transmit, to a user device, an indication of the at least one modification.

15. The non-transitory computer-readable medium of claim 14, wherein the indication of the at least one modification includes tracked changes relative to the at least one document.

16. The non-transitory computer-readable medium of claim 14, wherein the one or more instructions, when executed by the one or more processors, cause the device to:
receive, from the user device, a confirmation; and
transmit the at least one modification for display on an intranet, associated with the entity, in response to the confirmation.

17. The non-transitory computer-readable medium of claim 14, wherein the one or more instructions, when executed by the one or more processors, cause the device to:
receive, from the user device, a confirmation; and
output the document in a portable document format.

18. The non-transitory computer-readable medium of claim 14, wherein the one or more instructions, that cause the device to apply the machine learning model, cause the device to:
train the machine learning model using the at least one document; and
apply the trained machine learning model to the plurality of files to determine the at least one modification.

19. The non-transitory computer-readable medium of claim 14, wherein the one or more instructions, that cause the device to apply the machine learning model, cause the device to:
input the at least one document to a first set of input nodes associated with the machine learning model; and
input the plurality of files to a second set of input nodes associated with the machine learning model.

20. The non-transitory computer-readable medium of claim 14, wherein the plurality of files includes an image file, a video file, a hypertext markup language (HTML) file, or a portable document format file.
